(19) United States
(12) Patent Application Publication
(10) Pub. No.: US 2011/0095635 A1
(43) Pub. Date: Apr. 28, 2011

(54) Various motor assembly

(76) Inventors: Heung Yeung Li, Hong Kong (HK); Chun Man Li, Hong Kong (HK)

(21) Appl. No.: 12/673,106

(22) PCT Filed: Aug. 1, 2009
(86) PCT No.: PCT/CN09/73166

§ 371 Date: Feb. 11, 2010

(30) Foreign Application Priority Data
May 13, 2009 (CN) 2009100394708

(51) Int. Cl. H02K 16/00; H02K 21/12

(52) U.S. Cl. 310/112; 310/156.38

(57) ABSTRACT

A various motor assembly comprises at least one single motor allowing to enter a coding position at instant; a single-layer circular or cylindrical motor unit comprised of the at least one single motor; a multi-layer cylinder motor set piled from the single-layer circular or cylindrical motor unit, and including piled and horizontal cylinders, circular cylinders and conical cylinders, wherein the conical cylinders are numbered and located at aligned or unaligned positions.

### BACKGROUND OF THE INVENTION

1. Field of the Invention

The present invention relates to a various motor assembly that can be operated automatically in some places where the human can not reach before.

2. Description of the Prior Art

Conventional robot includes a mechanical arm to be controlled by an engine, however it does not include a tiny motor disposed therein to have quick and easy operation.

The present invention has arisen to mitigate and/or obviate the afore-described disadvantages.

### SUMMARY OF THE INVENTION

The primary object of the present invention is to provide a various motor assembly that can be operated automatically in some places where the human can not reach before.

A various motor assembly in accordance with the present invention comprises:

at least one single motor allowing to enter a coding position at instant;

a single-layer circular or cylindrical motor unit comprised of the at least one single motor;

a multi-layer cylinder motor set piled from the single-layer circular or cylindrical motor unit, and including piled and horizontal cylinders, circular cylinders and conical cylinders, wherein the conical cylinders are numbered and located at aligned or unaligned positions;

wherein the single-layer circular motor unit includes a plurality of single motors surrounded together to form a closed circle, and the single-layer cylinder motor unit includes plural single-layer stator loops and rotor loops, sizes of which are the same, and gaps between the stator and the rotor loops include piled cylinders, hence a number of the rotor loops is a layer number the same as that of the single motors;

wherein the piled structure is at least one single-layer cylinder motor unit and includes gaps piled upward to form the multi-layer cylinder motor set, and between two abutting stator loops is defined a stator; the horizontal structure is at least one single-layer circular motor unit and includes gaps piled upward to form the multi-layer horizontal motor set;

wherein a single-direction current line with a cut magnetic field includes a single power source or multi-power sources, and the multi-power sources are surrounded a circle to rotate, and an output includes an outer and an inner cylinders to output a huge motor; a conducting coil includes a driving power having an inner and an outer stator, and the inner and the outer stators include the same magnetic line, the rotors include different magnetic lines, and a driving power generated by using inertia includes a single power source and a multi-power source;

wherein the multi-layer cylinder motor unit includes the cylindrical piled motor set and the cylindrical horizontal motor set, and the cylindrical piled motor set are arranged in a few of tens, hundreds, and thousands layer manner; the multi-layer cylinder motor unit includes cylindrically piled tiny, micro motors having single power output, and a size of the motor is tiny as a toothpick;

wherein the multi-layer conically cylinder motor is a centrifugal motor and includes a permanent magnet, and a multi-power source having a single-direction current line with a cut magnetic field to form a high-speed centrifugal motor; the multi-layer conically cylindrical motor includes a plurality of aligned numbering positions and unaligned numbering positions, a permanent magnet, and a multi-power source having a single-direction current line with a cut magnetic field to form a preferred high-speed centrifugal motor;

wherein the multi-layer cylinder motor unit includes a few of ten millions motors to be operated simultaneously.

### BRIEF DESCRIPTION OF THE DRAWINGS

FIG. 1 shows a single layer of various motor assembly according to the present invention;

FIG. 2 shows another single layer of various motor assembly according to the present invention;

FIG. 3 shows the multi-layer cylinder motor unit being designed to have a single-direction magnetic field;

FIG. 4 shows a two-layer of cylinder motor unit;

FIG. 5 shows a partial wire structure of single-direction magnetic field of the multi-layer cylinder motor unit;

FIG. 6 shows a wire structure of a multi-layer cylinder motor unit;

FIG. 7 shows a power source of a conducting coil generating from the same direction of the magic wire of the stators;

FIG. 8 shows first, second, third, fourth, fifth, sixth, seventh, eighth, ninth, and tenth layers;

FIG. 9 shows a vertically aligned piled motor assembly;

FIG. 10 shows plural layers of motors;

FIG. 11 is a cross sectional view showing a motor with permanent-magnet and single-direction cutting magnetic field of the present invention;

FIG. 12 is a cross sectional view showing a huge multi-power motor with permanent-magnet and single-direction cutting magnetic field of the present invention;

FIG. 13 is a cross sectional view showing a huge and parallel-connection multi-power motor assembly with permanent-magnet and single-direction cutting magnetic field;

FIG. 14 is a cross sectional view showing thousands of huge motor assembly being assembled together to connect with two different gears (a rotor gear and a stator gear) and the first and second cylinders;

FIG. 15 shows a little mechanical animal comprised of mechanical arms having motors;

FIG. 16 is a cross sectional view showing a huge conically cylinder centrifugal motor assembly;

FIG. 17 shows a multi-power motor assembly with permanent magnet being used to draw pure liquid substances as an analyzer is installed therein;

FIG. 18 shows a rotating and tracking motor;

FIG. 19 shows a remote controlling arm including twelve joints to be controlled by one hand;

FIG. 20 shows a user controlling the mechanical arm by using three plate members and the tracking motor;

FIG. 21 is a huge motor assembly having a propeller used in sky;

FIG. 22 is a huge motor assembly having a propeller used in sea;

FIG. 23 shows a line structure of a multi-layer cylinder motor assembly;

FIG. 24 shows a line structure of a multi-layer centrifugal motor assembly;

FIG. 25 shows a small airplane;

FIG. 26 shows a plurality of naval vessels;

FIG. 27 is a small air vehicle with two seats to fly in an allowed range;

FIG. 28 shows a future traffic state;

FIG. 29 is a plan view showing an operation of a motor with a propeller;

FIG. 30 is a perspective view showing an operation of a motor with a propeller;

FIG. 31 is a perspective view showing an operation of a mechanical arm;

FIG. 32 is a plan view showing an operation of a small mechanical animal;

FIG. 33 is a perspective view showing a small mechanical animal to plant rice;

FIG. 34 is a plan view showing a mechanical cat to build a tunnel so as to save people;

FIG. 35 is a perspective view showing an operation of a synchronous motor assembly;

FIG. 36 shows an input program of an ant colony optimization to control a large group of motor assemblies;

FIG. 37 shows thermal energy being acquired from mantle to generate electricity;

FIG. 38 shows a grouting process to the gaps of the walls of the curst;

FIG. 39 shows an analogy machinery which allowing to walk, fly, and be operated in fire is utilized to put on the fire;

FIG. 40 shows numbers of ten millions huge fan motors being assembled together to transfer typhoon into tornado, and then the tornado being eliminated in the sky;

FIG. 41 shows motor assembly of the present invention being applied to vehicles used in land and ocean;

FIG. 42 shows multi-power motor assembly of the present invention being applied to vehicles used in land and ocean;

FIG. 43 shows the tornado moving along a platform and then being eliminated;

FIG. 44 shows a cylinder motor assembly being provided with a stator loop and a rotor loop connected by a conducting coil;

FIG. 45 shows a various motor assembly being used to an engine for matching with a dynamo;

FIG. 46 is a cross sectional view showing inner and outer cylinders of the engine and the connection between the stator loop or the rotor loop;

FIG. 47 shows a structure of a cylinder motor assembly of FIG. 44;

FIG. 48 shows a structure of multi-power motor having two adversely rotating permanent magnet and single-direction magnetic field;

FIG. 49 shows a single-direction current lines being assembled together to form huge, tiny, micro, and nano type of motor or nano mechanical arm;

FIG. 50 is a perspective view showing the structure of the permanent magnet, the rotor loop, and the stator loop.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

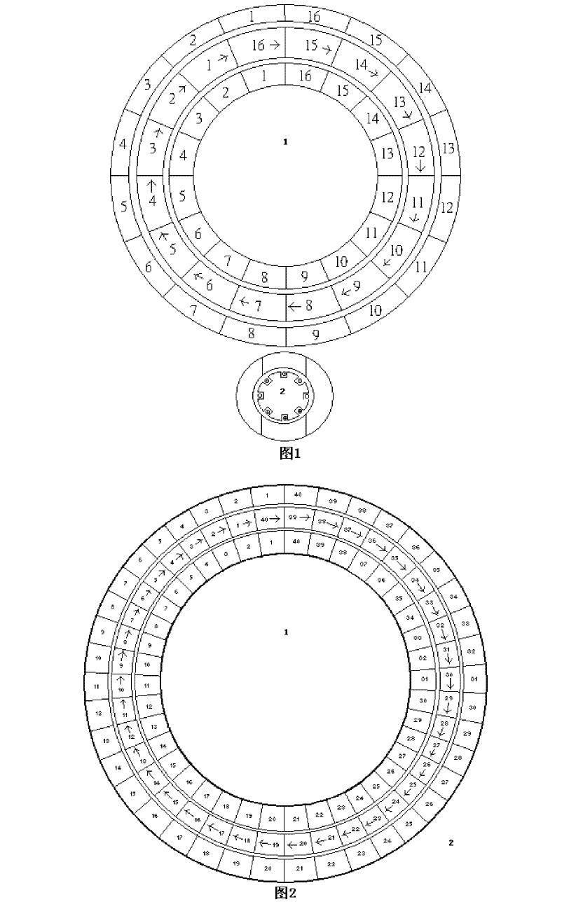

Referring to FIG. 1, a single layer of various motor assembly according to the present invention comprises a motor unit 1 including three circles of motor sets, each having sixteen motors, including a central hole, two stators disposed around inner and outer sides thereof, and a rotor mounted between the two stators, wherein the rotor rotates in a clockwise direction, and an arrow line shows a rotating direction, a conventional motor 2 including a plurality of wrapped lines disposed on a central portion thereof to form a solid rotor different from that of the present invention, and the ratio of an upper portion of FIG. 1 is decreased.

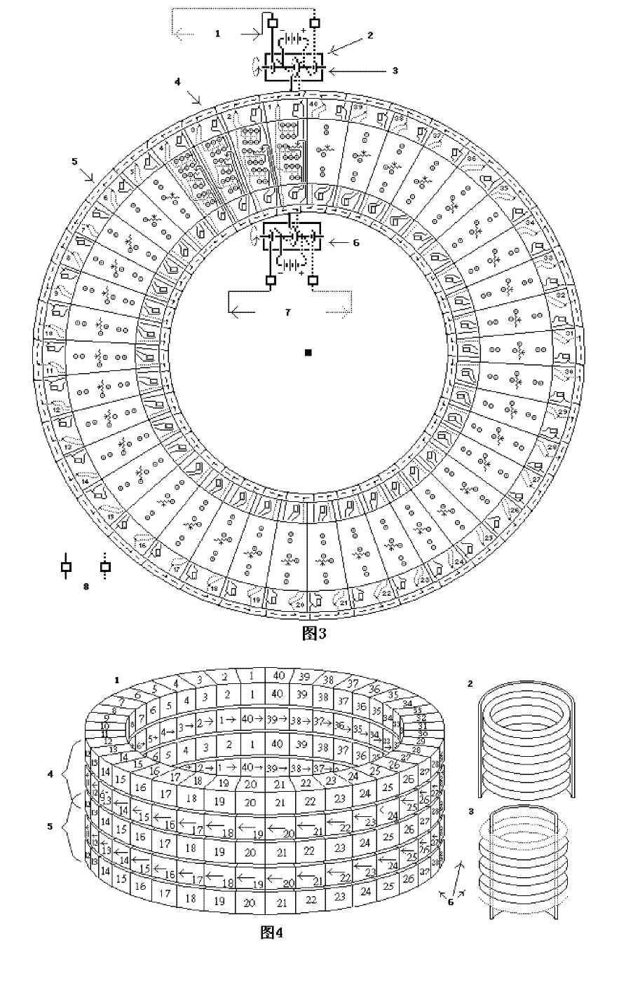

As shown in FIG. 2, a single layer of various motor assembly according to the present invention comprises a multi-layer cylindrical motor unit including three circles of motor sets, each having forty motors 1 to 40, wherein the three circles of motor sets are in the same size and disposed at the same plane to form a horizontally arranged motor assembly. In addition, the three circles of motor sets are in different sizes and piled up to form a cylindrically piled motor assembly 2.

As shown in FIG. 3, the multi-layer cylinder motor unit is designed to have a single-direction magnetic field and includes a signal input member 1. a first transforming shaft 2 includes two alloy pieces 3, 6 contacting a positive and negative voltage wheels, a line set 4, a simplified line 5, a second transforming shaft 7 to operate the rotor, and a third transforming shaft 8 to input signal.

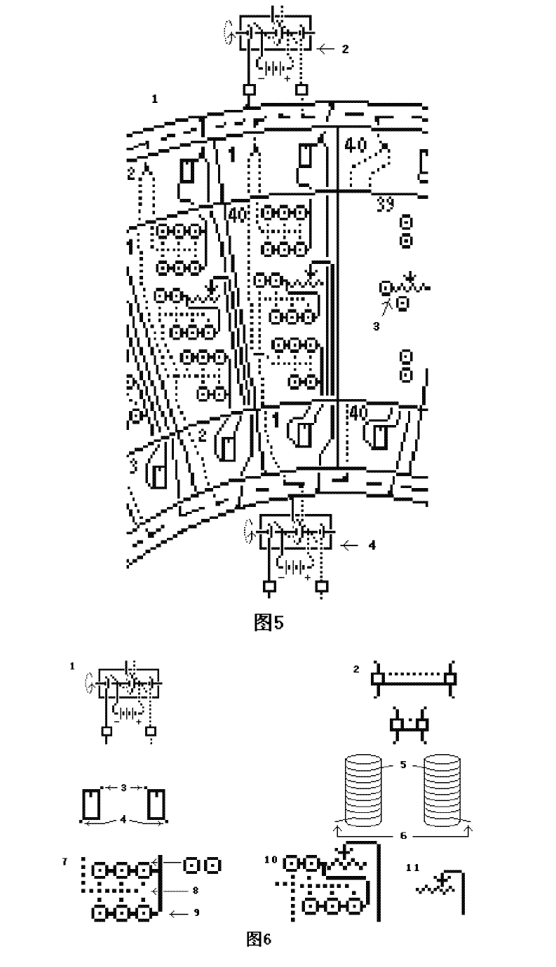

Referring to FIG. 4, a two-layer of cylinder motor unit includes a first cylinder member 1 to contact with a stator on an outer side of the motor assembly and a rotor, two second cylinder members 2 to connect with the stators and a bearing (not shown), a third cylinder member 3 to couple the rotor and a center of the bearing, a first layer 4 and a second layer 5.

FIG. 5 shows a partial wire structure of single-direction magnetic field of the multi-layer cylinder motor unit, wherein numeral 1 represents single-direction magnetic field, numeral 2 denotes a first transforming shaft numeral 3 indicates a central portion of a rotor, and numeral 4 represents a second transforming shaft.

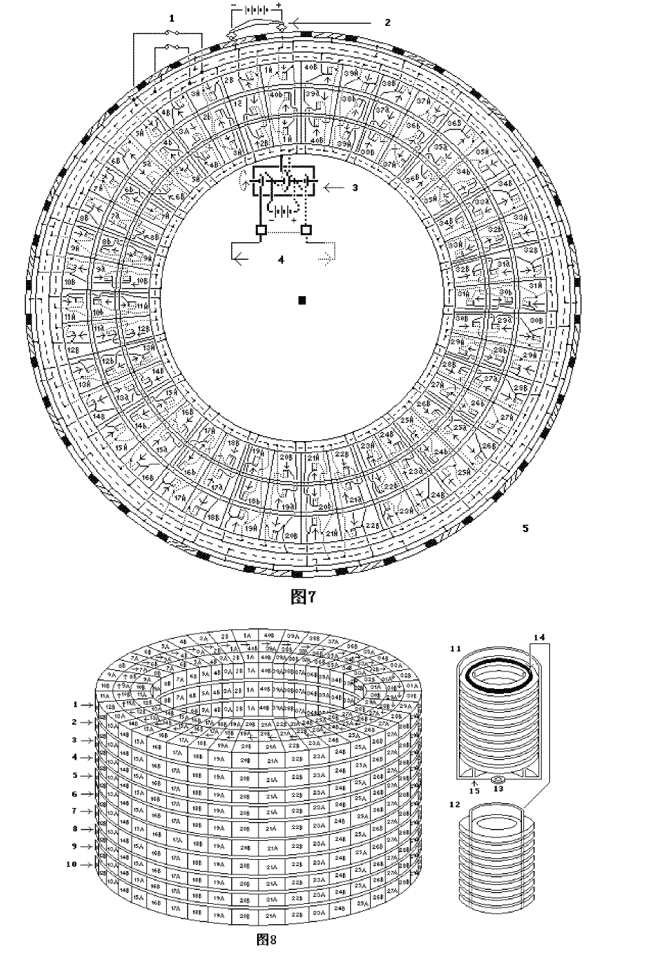

FIG. 6 shows a wire structure of a multi-layer cylinder motor unit, wherein numeral 1 represents a signal receiver to change a rotating direction of a first and a second transforming shafts, numeral 2 denotes the first transforming shaft transforms outer power into positive and negative voltages, and the second transforming shaft operates two sides of a rotor to rotate. Numeral 3 represents a wire is disposed upward to the multi-layer cylinder motor unit, numeral 4 denotes the wire mounted downward to the multi-layer cylinder motor unit, and numeral 5 represents a downward magic wire, numeral 6 represents an upward magic wire, numeral 7 is a transverse plan and includes a central point showing upward current, a dotted line 8 represents a lower end of the wire is in connection with a positive pole, and a solid line 9 denotes an upper end of the wire couples with a negative pole, a central portion 10 of the rotor is used to operate two sides of the multi-layer cylinder motor unit, and a control resistor 11 is used to decrease current.

As shown in FIG. 7, a power source of a conducting coil generates from the same direction of the magic wire of the stators, and an opposite magic direction of the rotor, and a repelling force from inertia. Numeral 1 is a centrifugal switch, numeral 2 represents alloy double wheels to change a line of a transforming shaft (as shown in FIG. 3), and the alloy pieces 3 contact with the positive and negative voltage wheel. A second transforming shaft 4 changes the positive and negative voltage by inputting a control program and changing wrapping direction of the conducting coil, thereby having the same rotating direction of the motor unit. Numeral 5 represents when the second transforming shaft is at a fixed voltage, the rotor is a permanent magnet to replace the conducting coil with different magic direction.

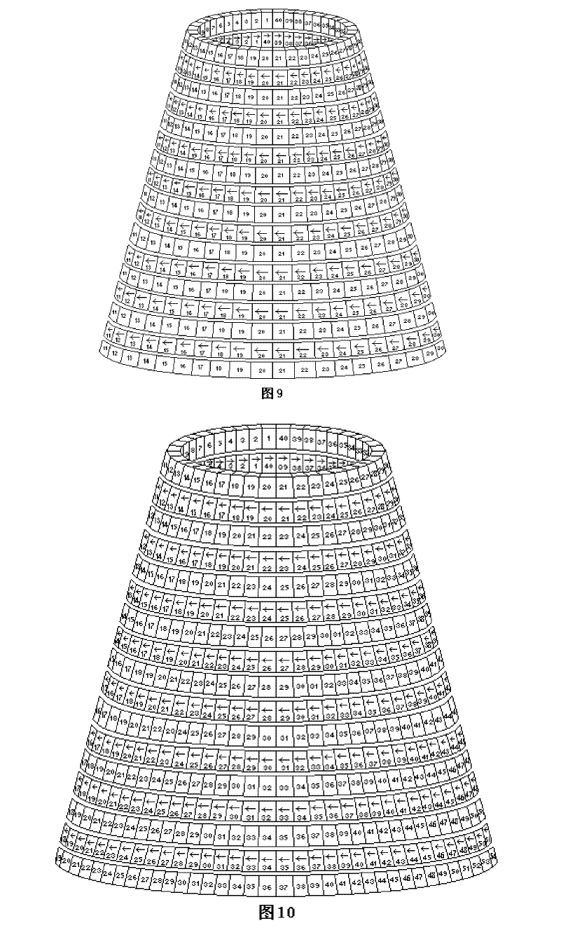

A ten layer of cylinder motor unit 40 as illustrated in FIG. 8, includes first, second, third, fourth, fifth, sixth, seventh, eighth, ninth, and tenth layers 1, 2, 3, 4, 5, 6, 7, 8, 9, and 10, and includes two vertically cut cylinders 11 each having an outer cylinder part to connect with stators and having two ends to couple with a bearing, includes an inner cylinder member 12 connecting with a rotor and having one end to couple with a center of the bearing, includes the bearing 13, an inner cylinder member on another end to be suspended, and a plurality of gaps 15, hence only one end of the third layer is fixed to an outer cylinder, having poor stability.

A vertically aligned piled motor assembly as illustrated in FIG. 9 includes a plurality pf chambers among the remarked positions thereof, and includes a rotor having a magic source from a conducting coil, however the wire structure of such a magic source is complicated.

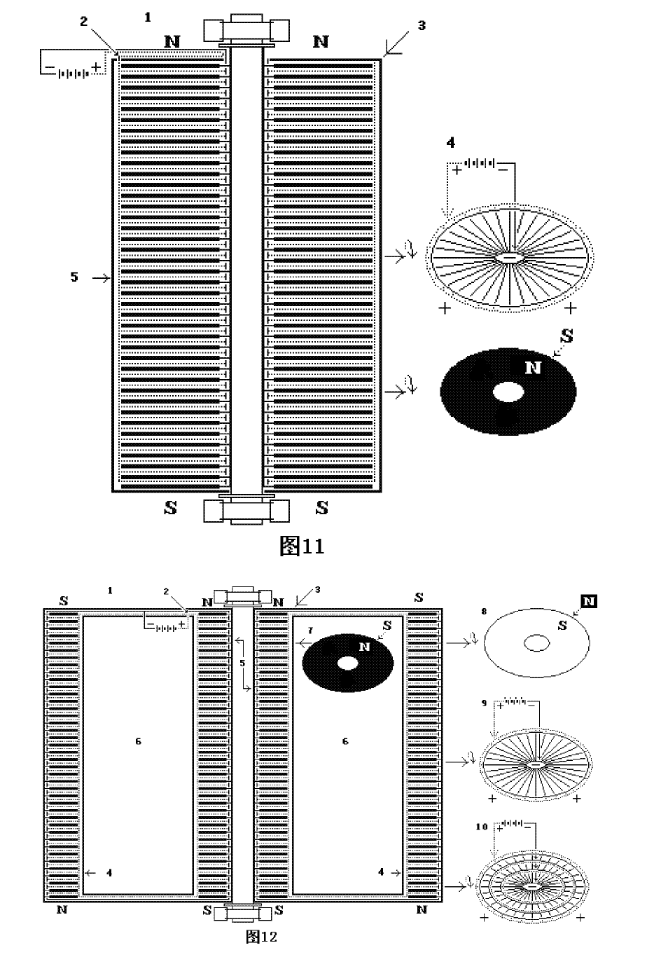

A conically cylinder centrifugal motor assembly as shown in FIG. 10, includes plural layer of motors, each having a plurality of numbering positions that are not in alignment with each other vertically, and the numbers of motors in each layer are not equal so as to save a space of the chamber. Likewise, the number of the numbering positions is decreased downward, however, the performance does not decreased but increase. It is to be noted that a single-direction cutting magnetic wire is a power source of the conically cylinder centrifugal motor assembly, and the wire structure is sample, thus enhancing efficiency.

FIG. 11 is a cross sectional view showing a motor with permanent-magnet and single-direction cutting magnetic field of the present invention, wherein a permanent magnet 1 is connected with the single-direction cutting magnetic field, and a covering member 2 is used to insolate an interference of the magnetic wire, and numeral, a housing 3 is applied to insolate an interference of the magnetic wire, a dotted lint 4 is connected with an outer circle and a solid line extending to an inner circle, and numeral 5 is a casing.

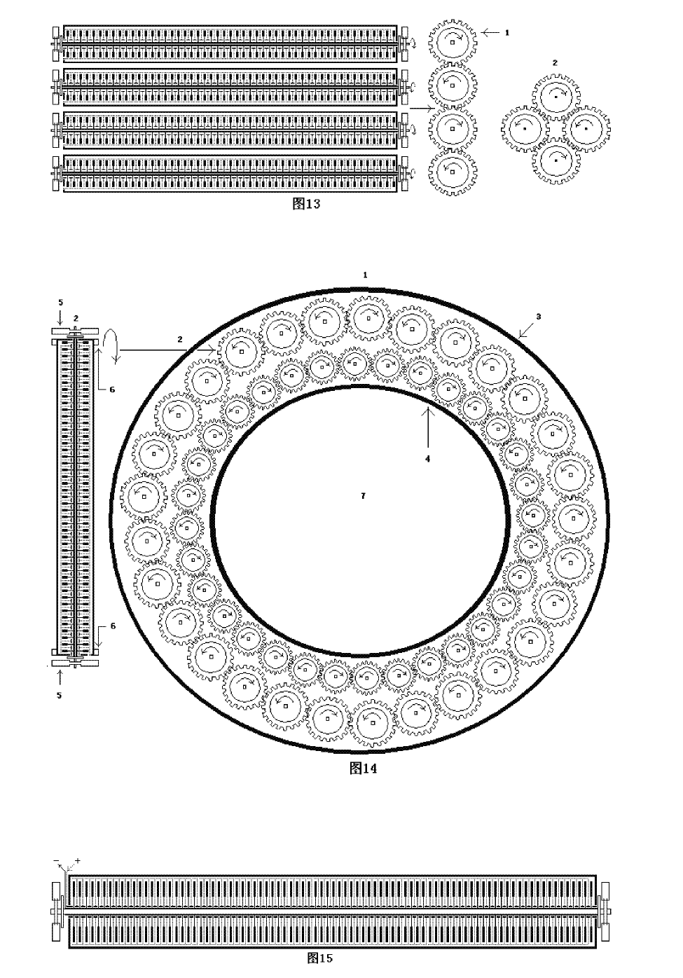

FIG. 12 is a cross sectional view showing a huge multi-power motor of a permanent-magnet and single-direction cutting magnetic field of the present invention, wherein the meaning of the “huge multi-power motor 1” is directed to a multi-power source and to transform one circle of single-direction current line into multi-circle of rotor circle, a covering member 2 is used to insolate an interference of the magnetic wire, and a housing 3 serves to insolate an interference of the magnetic wire, numeral 4 is an outer power source, numeral 5 is an inner power source, and numeral 6 is a chamber, numeral 7 denotes a permanent magnet of the inner power source, and numeral 8 is a permanent magnet of the outer power source, a dotted lint 9 is applied to connect with an outer circle and a solid line extending to a center of an inner circle, and another dotted line 10 is connected with the outer circle and a solid line extending to the inner circle, and a single-direction current line is cut into a plurality of circles, each having the same plane and a central point so that all current lines are arranged in a crowded manner, but are in the same rotor circle.

FIG. 13 is a cross sectional view showing a huge and parallel-connection multi-power motor assembly of a permanent-magnet and single-direction cutting magnetic field, numeral 1 represents the motor assembly is parallelly coupled to an output port, numeral 2 denotes a number of gears are connected to an output port in a bundle arrangement.

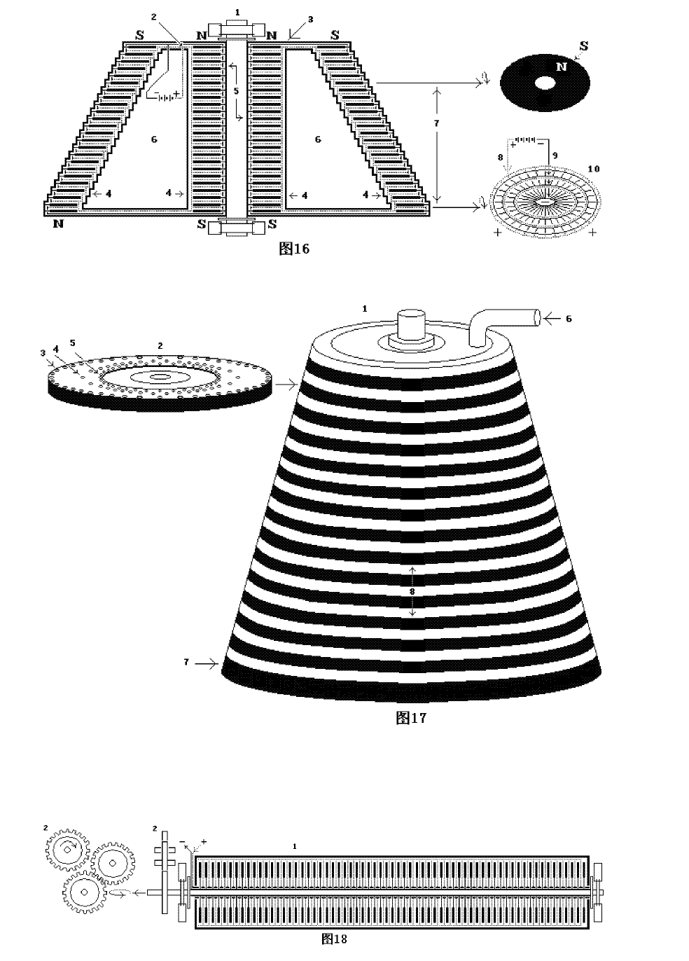

FIG. 14 is a cross sectional view showing thousands of huge motor assembly being assembled together to connect with two different gears (a rotor gear and a stator gear) and the first and second cylinders. Numeral 1 represents thousands of huge motors parallelly connect and output power source, numeral 2 denotes one gear represents one motor which has two ends connecting with two gears (the first and the second cylinder members), numerals 3 and 5 show a plurality of stator gears are coupled together and then connected to the first cylinder member; numerals 4 and 6 show a number of rotor gears are coupled together and then connected to the second cylinder member, and numeral 7 is a hollow hole to receive objects.

FIG. 15 shows a little mechanical animal comprised of mechanical arms having motors, the mechanical animal allows to walk and flies with wings.

The motor assembly allows to be installed to a mechanical arm to become a simulate robot, a simulate mechanical animal, or a drilling machine, and if the motor assembly includes a propeller disposed therein, it allows to operate in sky and sea, and if the motor assembly is used as a centrifugal motor, it becomes a high-speed centrifugal machine.

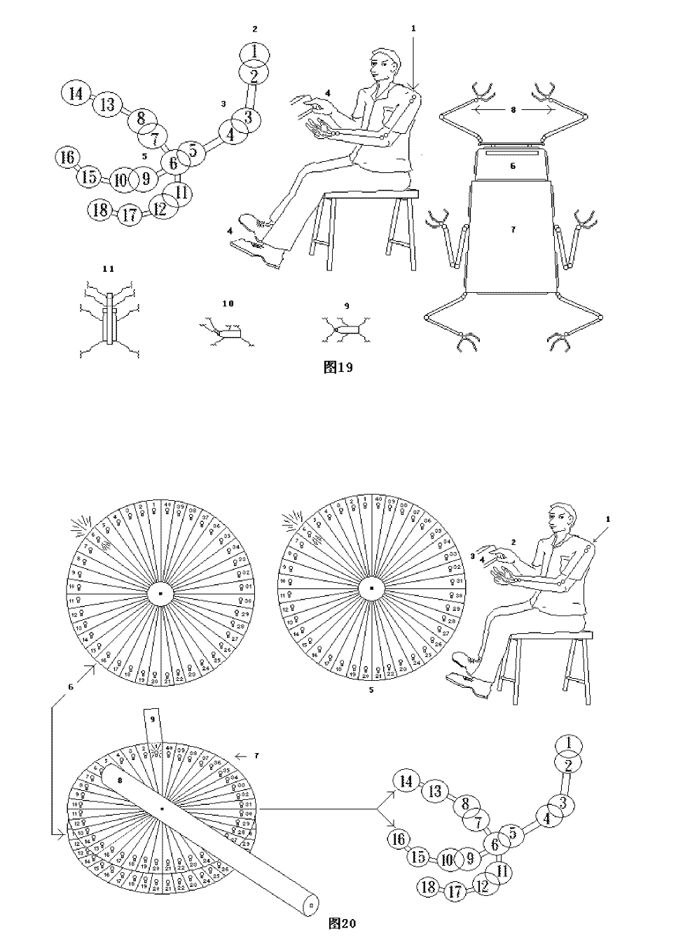

FIG. 16 is a cross sectional view showing a huge conically cylinder centrifugal motor assembly, wherein numeral 1 represents a huge centrifugal motor, numeral 2 denotes a covering member to insolate an interference of the magnetic wire and to be far away from the magic field, and numeral 3 denotes a housing to insolate an interference of the magnetic wire, numeral 4 is an external power source, numeral 5 is an internal power source, and numeral 6 is a chamber, numeral 7 is a stator and a rotor having the external and the internal power sources therein, numeral 8 is a dotted lint to connect with an outer circle and a solid line extending to an inner circle, and numeral 9 is a dotted line to connect with an outer circle and a solid line extending to an inner circle, and numeral 10 shows a plurality of circles being cut, and each circle has the same plane and a central point so that all current lines are arranged in a crowded manner, but are in the same rotor circle.

FIG. 17 shows a multi-power motor assembly with permanent magnet being used to draw pure liquid substances as an analyzer is installed therein, wherein numeral 1 represents a high-speed centrifugal motor having the analyzer installed therein, numeral 2 is a rotor having three sets of bores surrounded together for three bore loops, each has a lower end to connect with three channels, and each channel has an opening to connect with a switch to operate the analyzer so that the pure liquid substances are drawn to the channels. In addition, numeral 3 is an outer channel, numeral 4 is a middle channel, and numeral 5 is an inner channel, numeral 6 is a drawing pipe, and numeral 7 is an analyzer to convey the impure substances toward the channels to be purified.

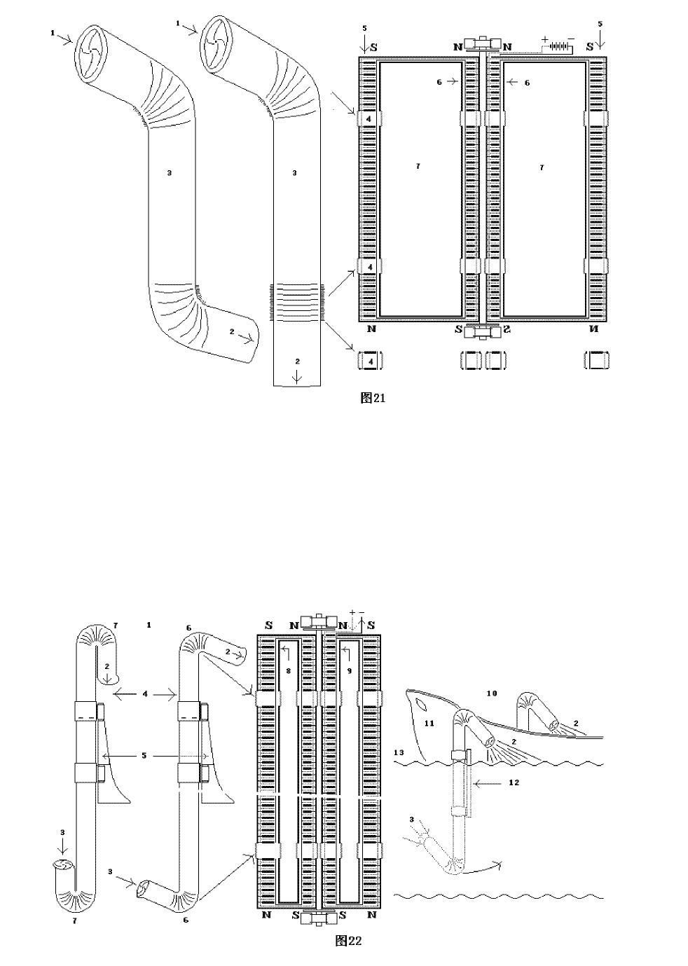

FIG. 18 is a rotating and tracking motor, wherein numeral 1 is a tracking motor to rotate in a single direction, numeral 2 is a switch to change rotating direction of the single gear or double gears, and the third gear is connected to the switch.

FIG. 19 shows a remote controlling arm including twelve joints to be controlled by one hand, wherein a user controls a pair of mechanical arms by using a left controlling arm 1, numerals 2 and 8 are the mechanical arms, numeral 3 shows the mechanical arm includes twelve joint controllers, wherein six controllers are controlled in a double control manner so as to be operated in a space, and the other controllers are a single controller to be operated on a plane, numeral 4 shows the user controls the machine by using hands and feet, numeral. 5 shows the user controls the machine by using three fingers, numeral. 6 is a control room, numeral 7 is wheels, numeral 9 is a small mechanical animal, numeral 10 is a web-footed mechanical animal, a small mechanical animal 11 is capable of moving and rotating.

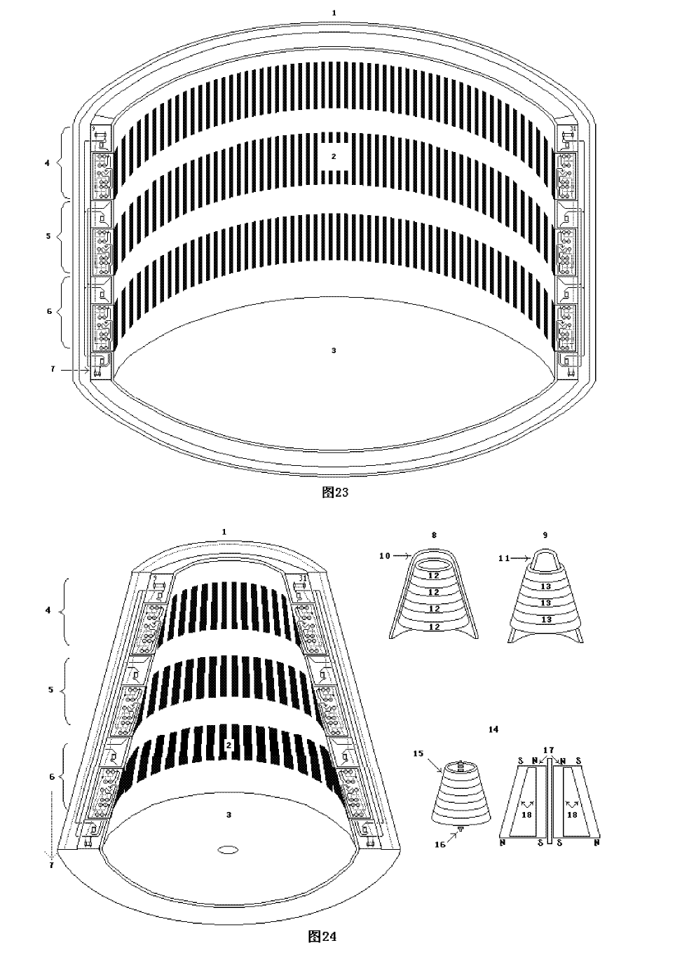

FIG. 20 shows a user controlling the mechanical arm by using three plate members and the tracking motor, wherein numeral 1 shows four kinds of signal sources, and one signal 1 is made from the mechanical arm by using the plate members and the tracking motor, numeral 2 is another signal 2 to be processed in a data base, numeral 3 is the other signal to reflect conditioned data from the data base, numeral 4 is a signal which reflects repeated and balanced motions in the data base. Furthermore, numeral 5 is a signal generator, numeral 6 is a signal receiver, numeral 7 is a signal tracker, and numeral 8 is a tracking motor capable of rotating in a single direction, and by replacing the signal or double gear, the rotating direction of the tracking motor is changed to eliminate signal difference, and numeral 9 is a mechanical arm.

FIG. 21 is a huge motor assembly having a propeller used in sky, wherein numeral 1 shows air entering, numeral 2 shows air exiting, numeral 3 is a propeller, numeral 4 shows a twisting and a straight control, numeral 5 is an external power source, and numeral 6 is an internal power source, numeral 7 is a chamber including the propeller installed therein to be used in sky.

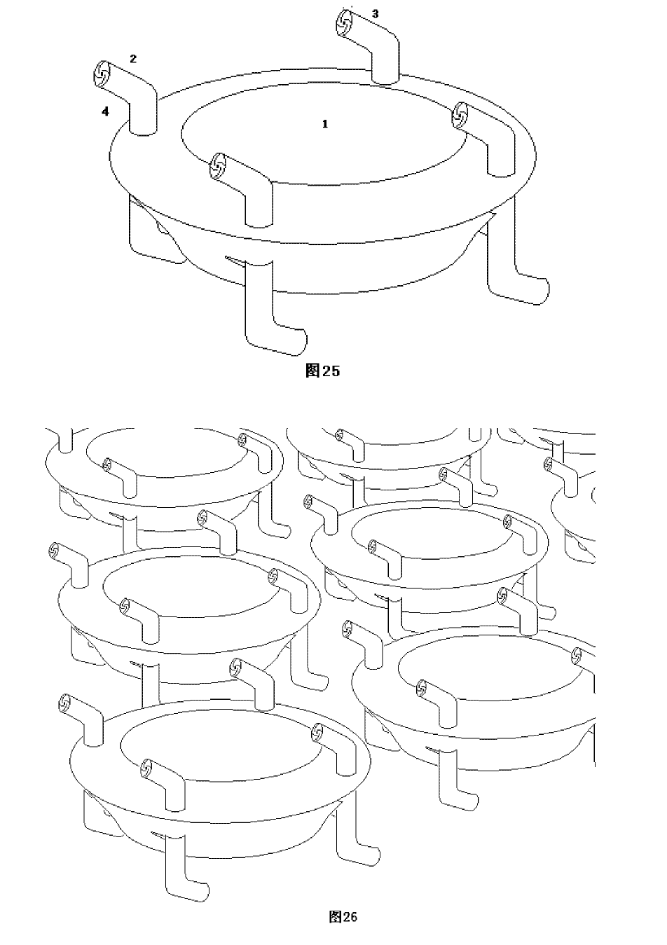

FIG. 22 is a huge motor assembly having a propeller used in sea, wherein numeral 1 is a water propeller, if it is a huge motor, the huge motor can be used in a large vessel, if the motor is a micro motor, it can be used in electronic protective field, numeral 2 is an entering operation, numeral 3 is an exiting operation, numeral 4 is a rotary member to change an operating direction, numerals 5, 12 show a positioning operation, and numeral 6 means making the vessel to move forward quickly, numeral 7 is a returning operation to make the vessel remain still, numeral 8 is an external power source, and numeral 9 is an internal power source. Moreover, numeral 10 is a water propeller, numeral 11 is a vessel body, numeral 13 is a water plane, and numeral 14 shows the vessel runs around a fixed point and then moves backward to increase speed and buoyancy.

FIG. 23 shows a line structure of a multi-layer cylinder motor assembly, wherein numeral 1 is a multi-layer cylinder motor, numeral 2 is a layer number of the multi-layer cylinder motor, numeral 3 is a stator loop including a number of coil loops or sole permanent magnetic loop, numerals 4, 5, 6 are a first, a second, and a third layers respectively, numeral 7 is a distal end of the stator layer, numeral 8 is a micro motor with low voltage, high sensitivity, multi-power and parallel-connection, and is used in remote controlling and automation process. The micro motor is also applied in manually intelligent input, deep embedding layer of reflected input of data base, and ant colony optimization.

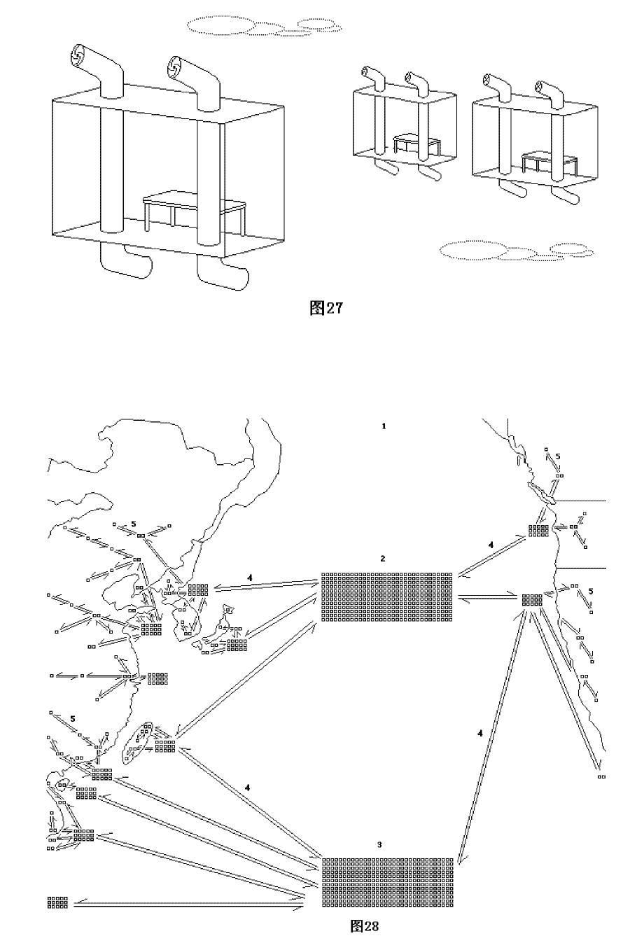

FIG. 24 shows a line structure of a multi-layer centrifugal motor assembly, wherein numeral 1 is a multi-layer centrifugal motor assembly, numeral 2 is a layer number of the motor assembly, numeral 3 represents a multi power source to be outputted in a parallel connecting manner, numerals 4, 5, 6 are a first, a second, and a third layers respectively, numeral 7 is a distal end of the stator, numeral 8 is two half of vertical cut cylinders, wherein a first cylinder member is connected to the stators and a bearing, numeral 9 is a second cylinder member coupled to the rotor and a center of the bearing, numeral 10 is a cut first cylinder member, numeral 11 is a cut second cylinder member, numeral 12 is a stator loop, and numeral 13 is a rotor loop, numeral 14 is a multi power source being connected parallelly to output power, numeral 15 is an external power source, numeral 16 is an internal power source, numeral 17 is an external cylinder member, and numeral 18 is an internal cylinder member.

FIG. 25 shows a small airplane, wherein numeral 1 is a small air vehicle, numeral 2 shows a plurality of air vehicles, numeral 3 shows four motors, numeral 4 represents two rows of motors, wherein the number of motor is a multiple of four, and the motors are arranged nearby the original motor to rotate together in the same direction, such that when a ship is overloaded, the motors are started to enhance power, increasing speed.

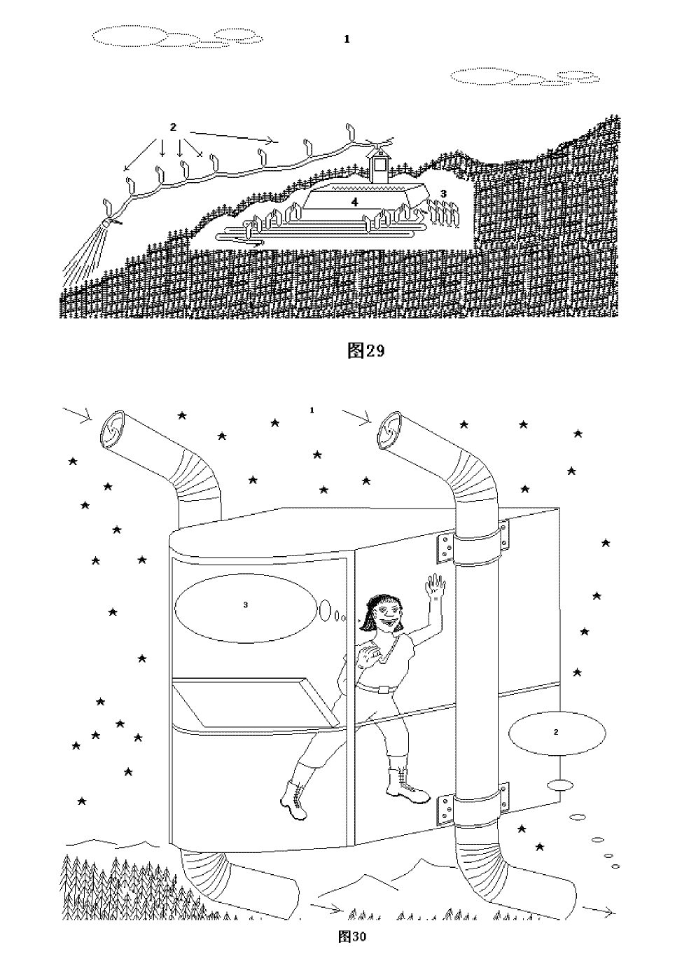

FIG. 26 shows a plurality of naval vessels, wherein numeral 1 is an aviatic vessel, numeral 2 is a small air plane that can transport staffs of an airplane company through a frame, a plane captain tunnel, a supply tunnel, and a plane tunnel.

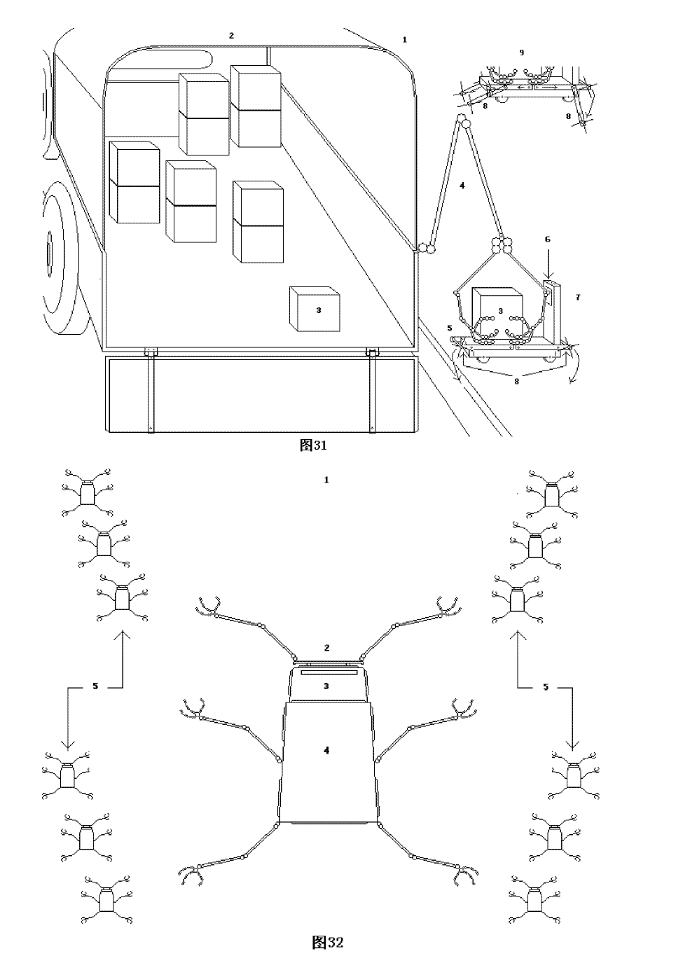

FIG. 27 is a small air vehicle with two seats to fly in an allowed range, wherein a flying room with double seats allows to fly in a designated sky.

FIG. 28 shows a future traffic state, wherein numeral 1 is a blue-printed plan, numeral 2 is an air vessel, numeral 3 is a naval vessel, numeral 4 shows a transporting operation, numeral 5 shows a plurality of fairways.

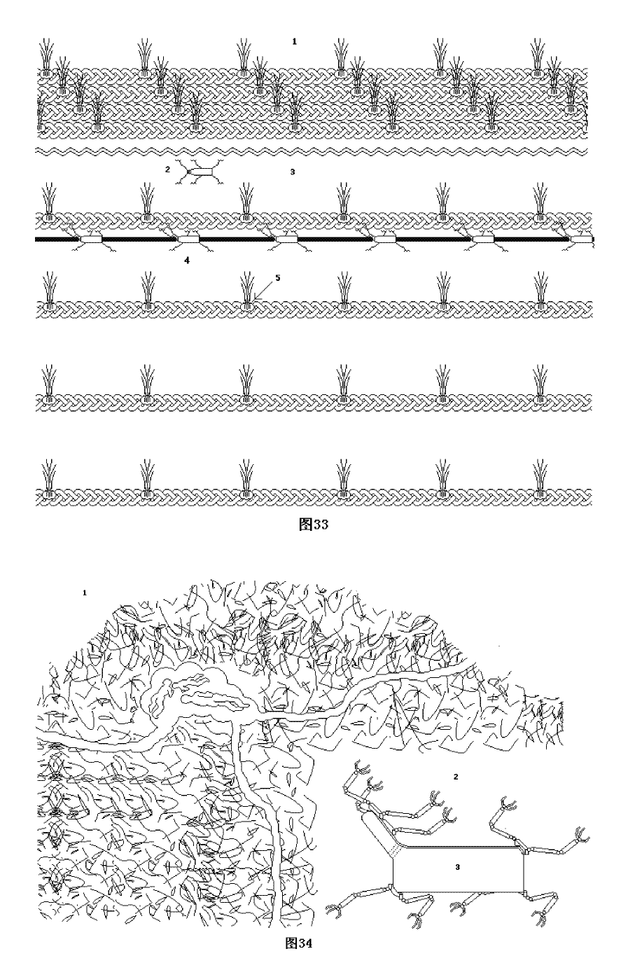

FIG. 29 is a plan view showing an operation of a motor with a propeller, wherein numeral 1 shows an operation of the motor with a propel, numeral 2 is a hanging tube to inject water, numeral 3 is an air propeller, and numeral 4 is a reservoir in the ground.

FIG. 30 is a perspective view showing an operation of a motor with a propeller, wherein numeral 1 is the motor with the propeller, numeral 2 shows a conversation between two workers in the sky.

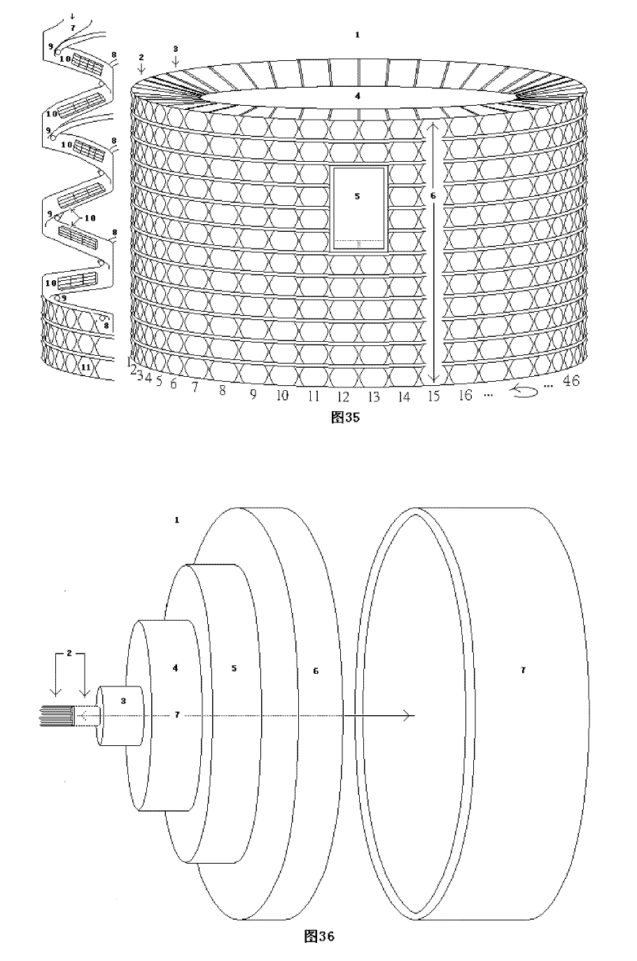

FIG. 31 is a perspective view showing an operation of a mechanical arm, wherein numeral 1 represents an order being inputted to the data base to operate the mechanical arm, numeral 2 is a truck, numeral 3 is merchandises, and numeral 4 is a mechanical arm to upload merchandises, numeral 5 is a mechanical car, numeral 6 is an input signal, numeral 7 is a transporting member, numeral 8 shows the operation of the truck, and numeral 9 is a palace operation during transporting process.

FIG. 32 is a plan view showing an operation of a small mechanical animal, wherein numeral 1 is a mechanical animal to catch dogs, numeral 2 shows the catching process, numeral 3 is a directing room, numeral 4 is a car, and numeral 5 is a robot.

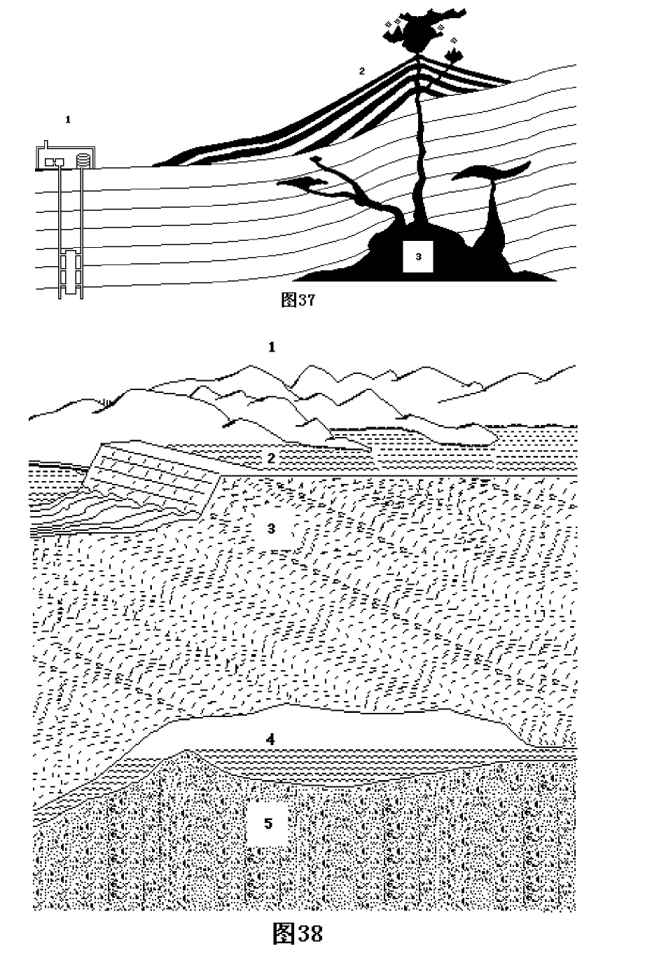

FIG. 33 is a perspective view showing a small mechanical animal to plant rice, wherein numeral 1 is a team of mechanical animals, numeral 2 shows a number of rows of rice, numeral 3 is a row of mechanical animal to plant rice, and the mechanical animal can be a duck with webbed-toes, numeral 4 represents size-decreased seedlings relative to a straw rope, and numeral 5 shows a plurality of marks made by the mechanical animals to protect rice.

FIG. 34 is plan view showing a mechanical cat to build a tunnel so as to save people, wherein numeral 1 is ruins, and numeral 2 is a mechanical cat, numeral 3 is a guide way on a back of a simulative mechanical cat having three pairs of mechanical arms to move on the track to drill, cut, transport, clean, and save people in the tunnel.

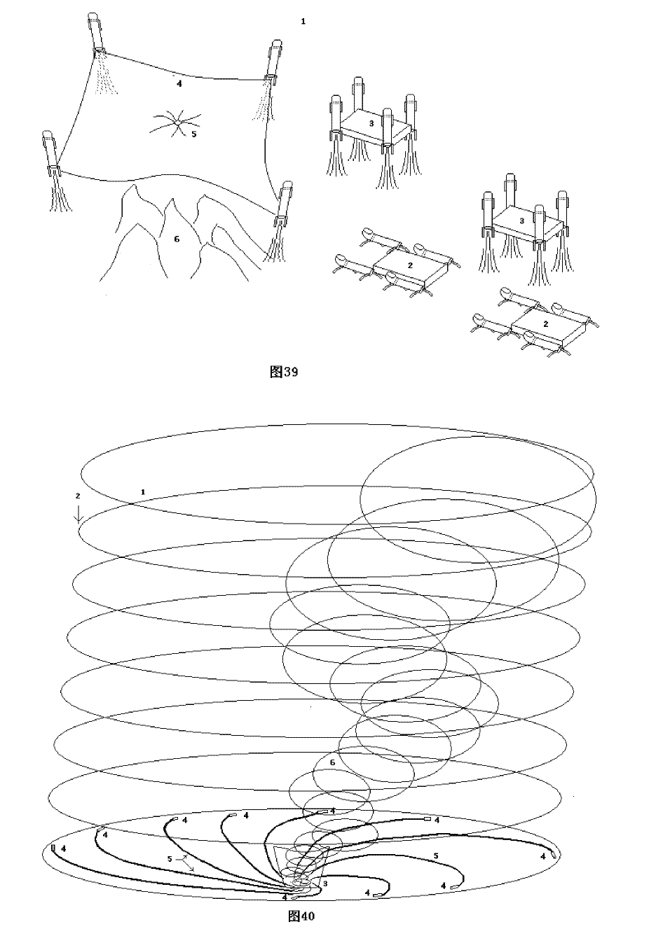

FIG. 35 is a perspective view showing an operation of a synchronous motor assembly, wherein numeral 1 is a motor assembly having a plurality of motors, numeral 2 is a column member to remotely control a grouting process from sea level to sea ground, numeral 3 is forty-six column members passing through forty-six robots so as to fit bag to an upper circular rim of the motor assembly, matching with material feeding, molding, grouting, and installing processes, numeral 4 represents feeding inward fully and reserving space inward, numeral 5 is two layer of glasses, numeral 6 is a column member, numeral 7 is a material feeding, numeral 8 means supporting a circle outward, numeral 9 represents retracting a circle inward, numeral 10 is a multi-layer net rib, and numeral 11 is a simultaneous process to the forty-six column members.

FIG. 36 shows an input program of an ant colony optimization to control a large group of motor assemblies, wherein numeral 1 is the input program of an ant colony optimization to control the large group of motor assemblies, numeral 2 is a plurality of drilling tools, numeral 3 is a number of drilling robots to expend drilling range, numeral 4 is a few tens of drilling robots, numeral 5 is a few hundreds of drilling robots, numeral 6 is a few thousands or ten thousands of drilling robots, wherein these numerous robots are inputted ant colony programs from the data base to deal with drilling works. Numeral 7 means after drilling the tunnels, the robots transport various pipes/tubes, connect the pipes/tubes together, and then grout to the connecting gaps of the pipes/tubes to have a strong reinforcement.

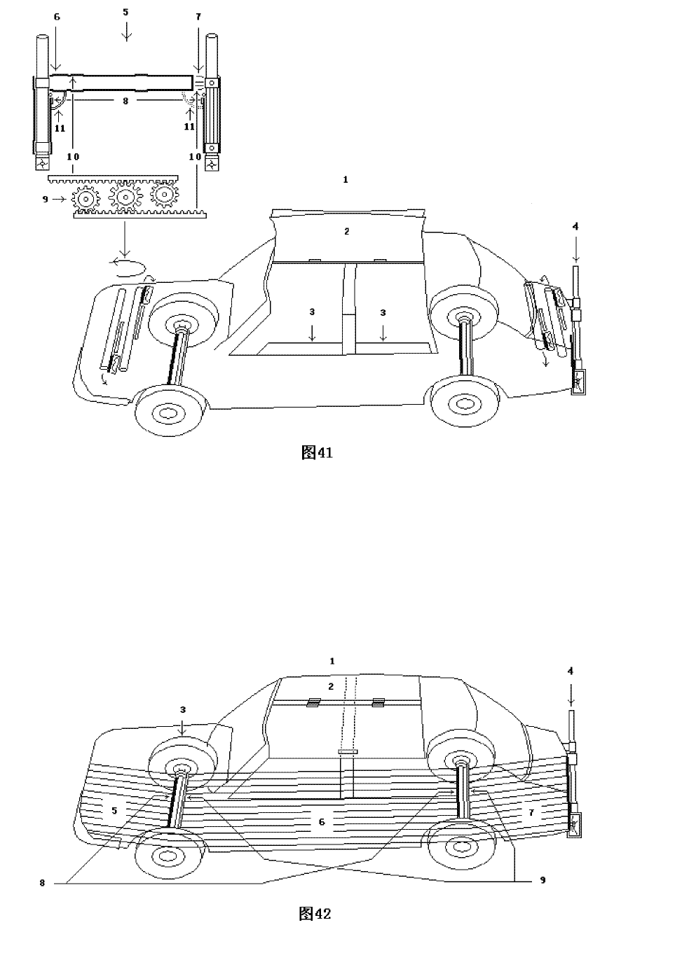

FIG. 37 shows thermal energy is acquired from mantle to generate electricity, wherein numeral 1 represents acquiring thermal energy from mantle to generate electricity, numeral 2 denotes building power plant nearby volcano areas, wherein the constructor has to prevent solidified magma from jamming an exit of the magma, the high temperature and pressure resisting equipments are used in tunnels to increase pressure and decrease temperature step by step. Thereafter, the variation of the pressure and the temperature are eliminated, and water is fed to the vaporization layer under safety condition, then the steam moves to the exit of the tunnels to actuate dynamos in the power plant and recycle surplus energy.

FIG. 38 shows a grouting process to the gaps of the walls of the curst, wherein numeral 1 is a grouting process to the gap of the walls of the curst, numeral 2 represents when an earthquake is detected that will happen in a large reservoir, the robots will have a grouting process to the gaps of the walls of the curst so as to prevent from damage in the earthquake. Numeral 3 denotes a cross section of the crust, numeral 4 shows steams exist in the gaps to from natural gas and groundwater, numeral 5 represents the above-mentioned approaches could be applied in 2008 Sichuan earthquake, including disaster areas or other zones.

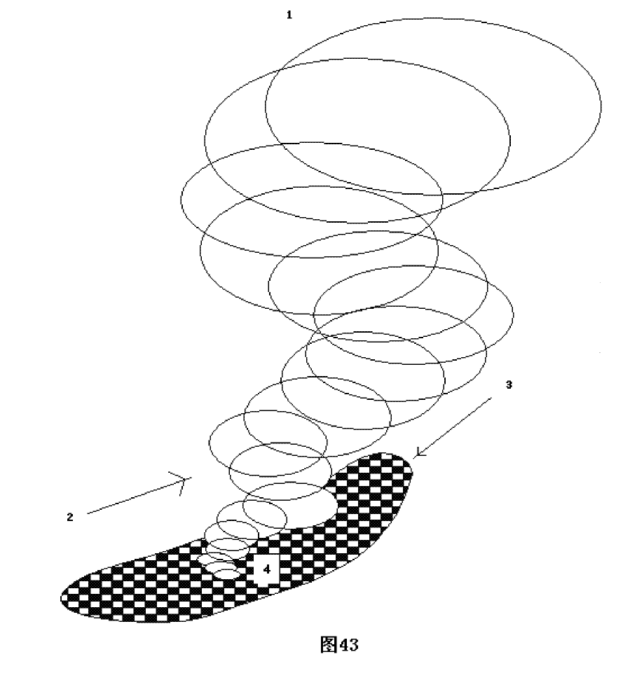

FIG. 39 shows an analogy machinery which allows to walk, fly, and be operated in fire is utilized to put on the fire, wherein numeral 1 represents a robot which allows to walk, fly, and be operated in the fire is used to put on a fire, and numeral 2 denotes plural sets of robots raise compressed and vacuum square cloth to walk toward the firing area, numeral 3 shows a number of robots fly and feed water into the compressed cloth to form a pyramid-shaped extinguishing member, and numeral 4 represents a plurality of extinguishing clothes are covered onto the flames, numeral 5 shown steams in the extinguishing members are released to lower temperature, and a circular cover is turned on to release hot air beneath the extinguishing members, and then the fire extinguishing agent is fed beneath the extinguishing members to put on fire, and numeral 6 is flames.

FIG. 40 shows numbers of ten millions huge fan motors are assembled together to transfer typhoon into tornado, and then the tornado is eliminated in the sky, wherein numeral 1 means whether this dream is carried out, because this experiment costs a lot of money, numeral 2 is a typhoon eye, numeral 3 represents the typhoon eye is lowered by the fan motors, and then a rotating wind is pushed upward to form a tornado so as to be eliminated in the sky, numeral 4 is plural fan motors, and numeral 5 is a climate, and numeral 6 is a tornado runs according to instructions, and is generated from a wind energy in the sea.

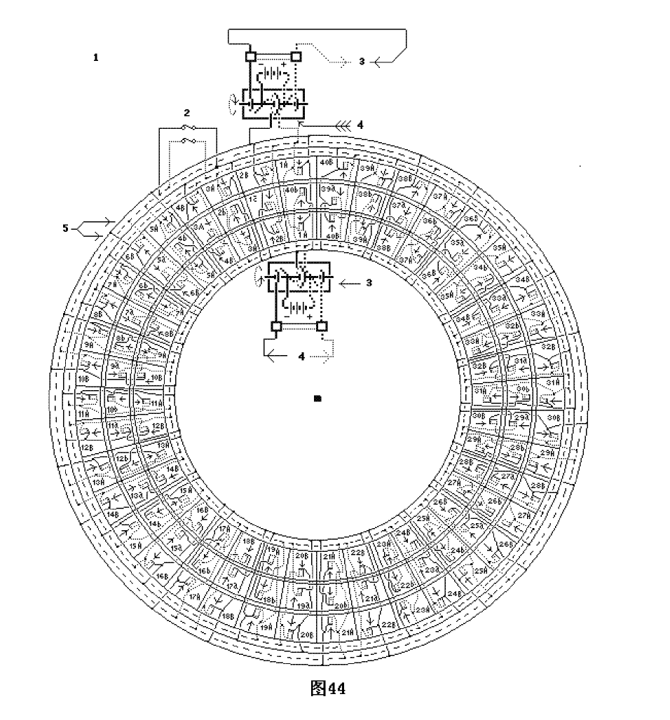

FIG. 41 shows motor assembly of the present invention is applied to vehicles used in land and ocean, wherein numeral 1 represents a car with five propellers to be used in land and ocean, numeral 2 denotes two opening doors, numeral 3 means moving downward, numeral 4 represents moving upward and downward, numeral 5 is three operating steps, including steps of extending a thruster outward from the car, positioning the thrust, and inserting the thrust into a fitting sleeve of a boat member of the car, numeral 6 denotes a front receiving member to receive the thrust, numeral 7 represents a rear receiving member to receive the thrust, and numeral 8 is a vertical receiving member fixed on an outer wall of the boat member, wherein a lower end of the vertical receiving member moves frontward to tilt the thrust and increase a water-injecting force to enhance buoyant and operating speed, numeral 9 is three gears, a middle gear is defined between a front and a rear gears, numeral 10 represents the three gears are installed to the gap between the lateral receiving members, numeral 11 denotes the gear is rotated to move the thrust vertically, and then the gear is received in the lateral or vertical receiving member.

FIG. 42 shows multi-power motor assembly of the present invention is applied to vehicles used in land and ocean, wherein numeral 1 shows a multi-power motor used in land and ocean, numeral 2 shows two doors are opened, and numeral 3 is a four-wheel anti-shake spring, numeral 4 is a thrust installed to a propeller on the boat for moving vertically or horizontally, numeral 5 is a number of huge motors to be disposed on a bottom of the car so as to drive the car, numeral 6 is a second row of huge motors, and numeral 7 is a third row of huge motors, numeral 8 represents a plurality of huge motors are parallelly outputted and connected to the wheel or the thrust, numeral 9 means a moving shaft is operated to control the running direction of the wheels.

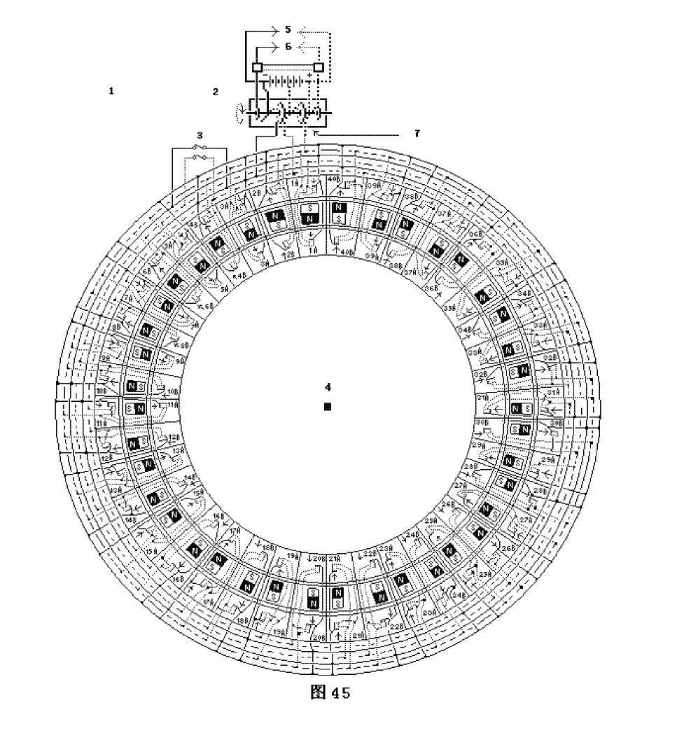

FIG. 43 shows the tornado moving along a platform and then being eliminated, wherein numeral 1 shows the tornado moves along the platform, and when it moves at a certain height, the tornado will be eliminated in the sky because the wind energy can not be fed to the tornado, numeral 2 is a method to control the tornado, wherein a moving direction and speed of the platform has to be identical to that of the moving tornado, and the numerous huge motors are inputted a control program from the data base to support the platform to move with the tornado, and when the tornado moves to a certain height, it can not acquire enough wind energy, therefore the tornado will disappear. Thereafter, another platform will be used to eliminate another tornado, and numeral 3 is a moving direction of the tornado, numeral 4 shows the tornado includes a plurality of feet to lift an object.

FIG. 44 shows a cylinder motor assembly is provided with a stator loop and a rotor loop connected by a conducting coil, wherein numeral 1 represents the stator loop and the rotor loop are connected by the conducting coil and installed in the cylinder motor assembly, numeral 2 denotes selecting a transforming shaft in the inner or the outer loop to transform the voltage, e.g. selecting the stator loop to change its opposite and negative voltages or selecting the rotor loop to change its opposite and negative voltages, and when the outer transforming shaft maintains in an original status, the inner transforming shaft transforms positive and negative voltage based on rotating amount, and three loops of motors are assembled together to form a single layer of cylinder motor unit, and plural single layers of cylinder motor units are piled together, and one of the two abutting stators is selectively fixed to the cylinder motor units, wherein if the stator loop is replaced by the permanent magnet to change a magnetic direction, the efficiency of the motor assemblies are the same. Besides, numeral 1 is an input program of the transforming shaft, and numeral 2 denotes a mechanical input of the transforming shaft, wherein two alloy pieces contact with the positive and the negative voltages respectively, and numeral 3 is a centrifugal switch.

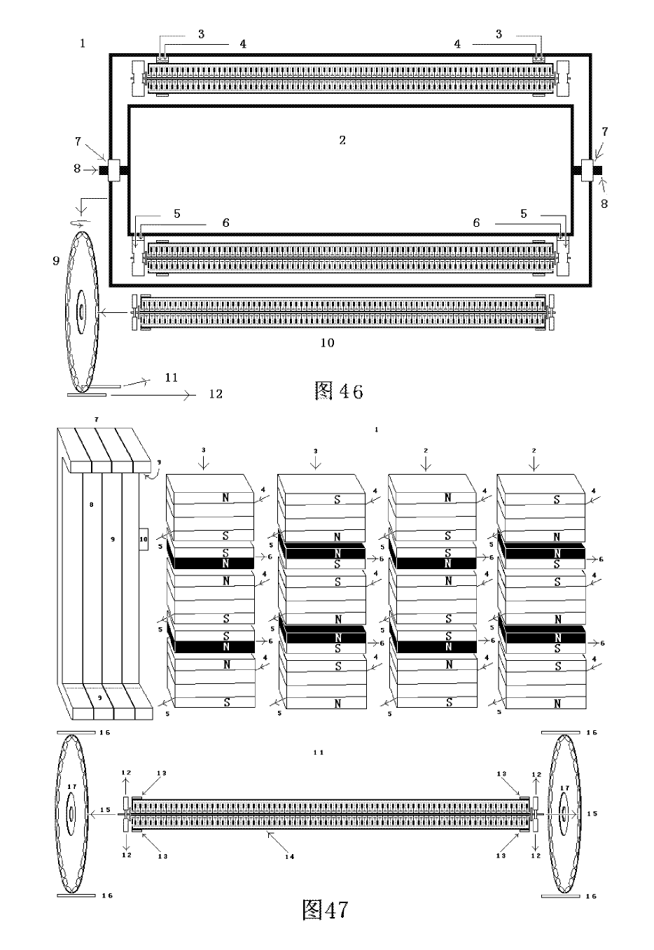

FIG. 45 shows a various motor assembly is used to an engine for matching with a dynamo, wherein numeral 1 is the engine for matching with the dynamo and includes a multi-layer various motor unit, numeral 2 means that the structure of the dynamo is similar to that of the engine, but they have different power sources and outputs, the power source of the dynamo is potential energy, thermal energy, wind energy, and chemical energy; the dynamo applies electrical energy supplement to actuate magnetic source at an instant input, and a connecting bar is actuated by the magnetic source. In addition, a centrifugal switch is started to provide inertia rotating force to operate the connecting bar in data base, and the electric switches cooperate with an input program to operate the connecting bar precisely, and numeral 3 is the centrifugal switch to provide inertia rotating force, numeral 4 is an engine of the input power, numeral 5 is an electricity output, and numeral 6 is an input program of the transforming shaft, and numeral 7 is a mechanical input of the transforming shaft, and a battery of the engine.

FIG. 46 is a cross sectional view showing inner and outer cylinders of the engine and the connection between the stator loop or the rotor loop, wherein numeral 1 is a four-layer engine with an inner and an outer cylinders, and the inner and the outer cylinders are provided with a stator loop or a rotor loop, numeral 2 shows the stator loop is mounted to the outer cylinder, and two ends of the outer cylinder are in connection with a bearing, numeral 3 represents rotor loops are secured to inner cylinders, and two ends of the inner cylinder are coupled to a center of the bearing, numeral 4 is an outer cylinder, and numeral 5 is an inner cylinder.

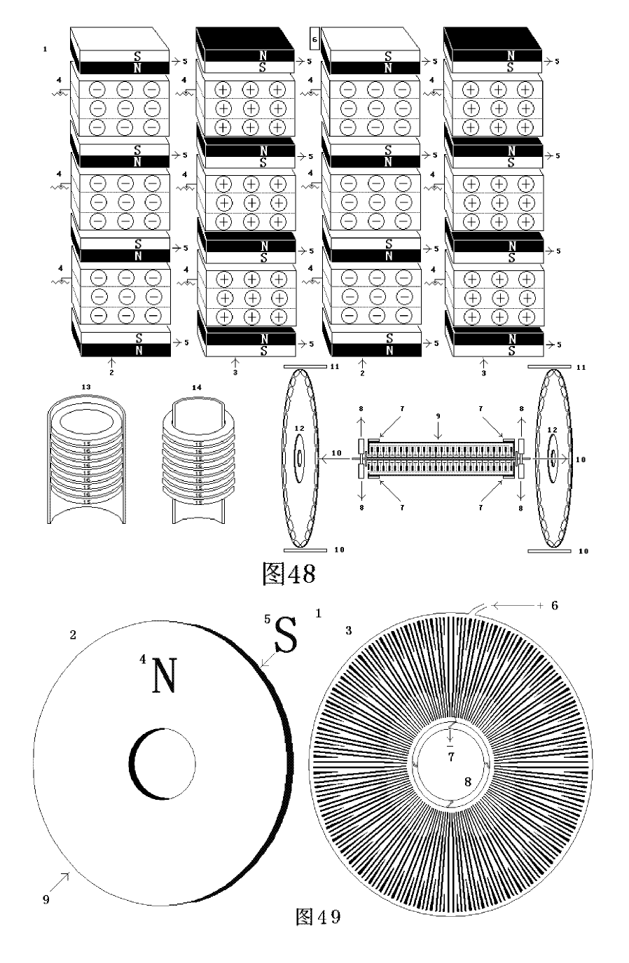

FIG. 47 shows a structure of a cylinder motor assembly of FIG. 44, wherein numeral 1 denotes a cylinder motor with a permanent magnet and a conducting coil, numeral 2 means that if an inner loop has a fixed voltage, an outer transforming shaft (not shown) will transform positive and negative voltages based on each rotating unit, and even the conducting coil is changed, the rotating direction of the rotor remain unchanged, numeral 3 is a centrifugal switch (not shown, and after the inertia rotating force generates, electronic circuit between two rotating unit marked as the same numeral, e.g., 2, 2 to 4, 4, are connected to the power from the centrifugal switch), numeral 4 shows the conducting coil is rotated in one direction, and numeral 5 means the conducting coil is rotated in another direction, numeral 6 is a rotating direction of the rotor of the permanent magnet, and numeral 7 is a silicon steel core to prevent from magnetic interference, numeral 8 shows the silicon steel core is fixed to the contacting surface of two ends of the single stator pillar, and the other components are covered by a magnetic shielding paper, numeral 9 is an unsealing surface to contact with the stator pillar, numeral 10 shows only one cylinder motor assembly is installed to an electrical sensor beside the silicon steel core, and when the rotor meets with the electrical sensors, the outer transforming shaft transforms the positive and the negative voltages of the conducting coil of the stator, and the rotating direction of the conducting coil is changed so that the rotating direction of the permanent magnet remains unchanged. In addition, numeral 11 represents a number of huge motors are inputted parallelly, and numeral 12 denotes each motor includes an outer cylinder to connect with two gears, numeral 13 means an inner cylinder of the motor includes a front and a rear ends to couple with the two gears, numeral 14 indicates twenty-six motors are installed to oval areas, numeral 15 shows the gears of the inner and the outer cylinders are connected and arranged in a cross manner, and the gears connect with an outer cylinder, a shaft center in the same rotating direction has a parallel output, and numeral 16 denotes a position of the outer cylinder, numeral 17 shows an inner cylinder coupling to a center of a bearing.

FIG. 48 shows a structure of multi-power motor having two adversely rotating permanent magnet and single-direction magnetic field, wherein numeral 1 is the multi-power motor having two adversely rotating permanent magnet and single-direction magnetic field, numeral 2 is the permanent magnet having two rotor loops fixed to two ends of the permanent magnet, and the two abutting permanent magnets have different magnetic directions N and S, the rotor loop is disposed to a center of the bearing, numeral 3 is a stator loop with single-direction current line, and the stator loop is defined between the rotor loops, and two abutting current lines change current directions relatively into each other, the stator loop is mounted in an outer cylinder of the bearing, and numeral 4 represents an electrical resistor series connected between the stators to accelerate, decelerate, or stop the motor and operated by the data base, numeral 5 is a rotating direction of the rotor, and numeral 6 shows an electrical sensor installed in the outer cylinder, and the rotor loop actuates the single-direction current line of the stator to change its positive and negative current direction, and the magnetic direction of the permanent magnet remains unchanged, numeral 7 shows each motor includes an outer cylinder having tow gears disposed on a front and a rear ends thereof individually, and numeral 8 shows a center of each motor includes two gears installed on a front and a rear ends thereof respectively, numeral 9 shows twenty-six motors are mounted in two oval areas, and numeral 10 indicates the gears of the motors are connected together and form a cross circle, the gears are further arranged to the outer cylinder and the shaft center, thereby obtaining a parallel connecting output of the motors, numeral 11 is a position of the outer cylinder, numeral 12 is the shaft center, numeral 13 shows the outer cylinder is coupled to the stator loop, numeral 14 denotes an inner cylinder is in connection with the rotor loop, and numeral 15 is the rotor loop, numeral 16 is the stator loop.

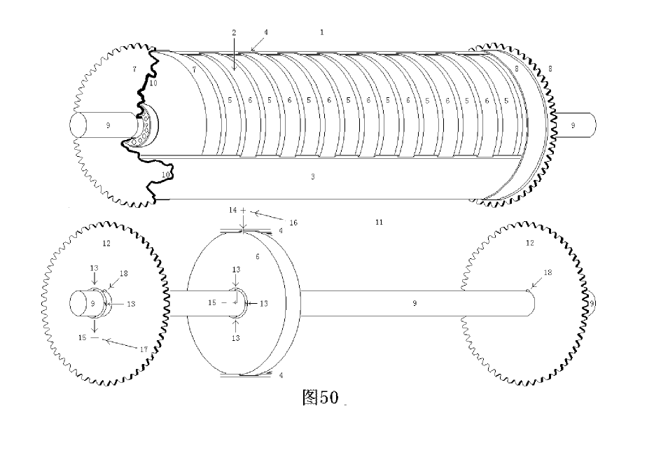

It is to be noted that the descriptions of FIGS. 1-48 is concerned to general various motor assemblies, but the most excellent motor assembly of the present invention is shown in the following FIGS. 49 and 50.

FIG. 49 shows a single-direction current lines are assembled together to form huge, tiny, micro, and nano type of motor or nano mechanical arm, wherein numeral 1 shows a piece of current line is utilized to the motor assembly or single-direction current line set. Furthermore, a method of making the single-direction current line includes applying a laser to cut a thin copper piece, or utilizing a circuit board to print the single-direction current line, or arranging electrical lines to a nano copper piece, or using a nano etching technology to form the thin pieces, numeral 2 is a conducting line to connect with single-direction current lines, and the current lines are piled together to form a conducting circuit and coupled to the positive voltage and the negative voltage, numeral 3 is a conducting line to connect with single-direction current lines, and the current lines are piled together to form a conducting circuit and coupled to the negative voltage through a resilient alloy brush, numeral 4 is the resilient alloy brush, and four brushes are surrounded together to generate a circle and to be connected to the negative voltage, numeral 5 is another four alloy brushes, and numeral 6 is an output of the positive current of the electrical circuit, numeral 7 shows the negative current of the circuit conducts through he shaft center to be outputted.

FIG. 50 is a perspective view showing the structure of the permanent magnet, the rotor loop, and the stator loop, wherein numeral 1 is the various motor assembly having the permanent magnet, the rotor loop, and the stator loop to obtain a continuous driving capability, and numeral 2 is a lip covered on the elongated slot and having the rotor loop disposed at a shaft center, and having the stator loop inserted to an arcuate groove of the slot, numeral 3 shows two arcuate grooves inserted to the stator loop and then are positioned by glue, wherein before the stator loop is inserted to the arcuate groove, the rotor loop, the stator loop, and the gears are inserted to the shaft center, numeral 4 shows the certain slot includes an arcuate groove having a hole to pass the positive wire, and the slot is covered by a lip. Thereafter, the glue is used to seal the lip, and numeral 5 is a rotor loop of the permanent magnet, wherein the rotor loops are installed to two ends of the shaft center, numeral 6 is a stator loop with a single-direction current line to be fixed between the rotor loops, numeral 7 is a first gear, and numeral 8 is a second gear, numeral 9 is the shaft center, and numeral 10 is a cross section. Moreover, numeral 11 shows the circuit of the positive and the negative currents are marked, numeral 12 represents the first and the second gears are secured to the shaft center, numeral 13 denotes a brush loop of the alloy pieces is defined between the stator loop and the rotating shaft center, and numeral 14 shows a positive power is inputted, numeral 15 represents a negative power is outputted, numeral 16 is a circuit of the positive current, and numeral 17 is a circuit of the negative current, numeral 18 is a bolt element to position the gear.

While we have shown and described various embodiments in accordance with the present invention, it is clear to those skilled in the art that further embodiments may be made without departing from the scope of the present invention.

What is claimed is:

1. A various motor assembly comprising:
at least one single motor allowing to enter a coding position at instant;
a single-layer circular or cylindrical motor unit comprised of the at least one single motor;
a multi-layer cylinder motor set piled from the single-layer circular or cylindrical motor unit, and including piled and horizontal cylinders, circular cylinders and conical cylinders, wherein the conical cylinders are numbered and located at aligned or unaligned positions.

2. The various motor assembly as claimed in claim 1, wherein the single-layer circular motor unit includes a plurality of single motors surrounded together to form a closed circle, and the single-layer cylinder motor unit includes plural single-layer stator loops and rotor loops, sizes of which are the same, and gaps between the stator and the rotor loops include piled cylinders, hence a number of the rotor loops is a layer number the same as that of the single motors.

3. The various motor assembly as claimed in claim 1, wherein the piled structure is at least one single-layer cylinder motor unit and includes gaps piled upward to form the multi-layer cylinder motor set, and between two abutting stator loops is defined a stator; the horizontal structure is at least one single-layer circular motor unit and includes gaps piled upward to form the multi-layer horizontal motor set.

4. The various motor assembly as claimed in claim 1, wherein a single-direction current line with a cut magnetic field includes a single power source or multi-power sources, and the multi-power sources are surrounded a circle to rotate, and an output includes an outer and an inner cylinders to output a huge motor; a conducting coil includes a driving power having an inner and an outer stator, and the inner and the outer stators include the same magnetic line, the rotors include different magnetic lines, and a driving power generated by using inertia includes a single power source and a multi-power source.

5. The various motor assembly as claimed in claim 1, wherein the multi-layer cylinder motor unit includes the cylindrical piled motor set and the cylindrical horizontal motor set, and the cylindrical piled motor set are arranged in a few of tens, hundreds, and thousands layer manner; the multi-layer cylinder motor unit includes cylindrically piled tiny, micro motors having single power output, and a size of the motor is tiny as a toothpick.

6. The various motor assembly as claimed in claim 1, wherein the multi-layer conically cylinder motor is a centrifugal motor and includes a permanent magnet, and a multi-power source having a single-direction current line with a cut magnetic field to form a high-speed centrifugal motor; the multi-layer conically cylindrical motor includes a plurality of aligned numbering positions and unaligned numbering positions, a permanent magnet, and a multi-power source having a single-direction current line with a cut magnetic field to form a preferred high-speed centrifugal motor.

7. The various motor assembly as claimed in claim 1, wherein the multi-layer cylinder motor unit includes a few of ten millions motors to be operated simultaneously.
